(19) United States
(12) Patent Application Publication
(10) Pub. No.: US 2023/0407062 A1
(43) Pub. Date: Dec. 21, 2023

(54) LOW-DIELECTRIC SUBSTRATE MATERIAL AND METAL SUBSTRATE USING THE SAME

(71) Applicant: NAN YA PLASTICS CORPORATION, Taipei (TW)

(72) Inventors: TE-CHAO LIAO, TAIPEI (TW); HUNG-YI CHANG, TAIPEI (TW); WEI-RU HUANG, TAIPEI (TW); CHIA-LIN LIU, TAIPEI (TW)

(21) Appl. No.: 17/976,959

(22) Filed: Oct. 31, 2022

(30) Foreign Application Priority Data
Jun. 16, 2022 (TW) 111122318

(51) Int. Cl. C08L 21/00; C08L 71/12; C08K 7/26; C08K 5/00

(52) U.S. Cl. CPC C08L 21/00; C08L 71/12; C08L 2203/20; C08K 5/0025; C08K 2201/005; C08K 7/26

(57) ABSTRACT

A low-dielectric substrate material and a metal substrate using the same are provided. The low-dielectric substrate material includes a rubber resin composition, at least one inorganic filler, and borosilicate-type hollow microparticles. The rubber resin composition includes 30 wt % to 60 wt % of a liquid rubber, 10 wt % to 40 wt % of a polyphenylene ether resin, and 10 wt % to 40 wt % of a crosslinker. A molecular weight of the liquid rubber ranges from 2500 g/mol to 6000 g/mol. The at least one inorganic filler is selected from the group consisting of magnesium oxide, aluminum oxide, silicon oxide, zinc oxide, aluminum nitride, boron nitride, silicon carbide, and aluminum silicate. An amount of the borosilicate-type hollow microparticles is not more than 10 phr relative to 100 phr of the rubber resin composition.

### CROSS-REFERENCE TO RELATED PATENT APPLICATION

This application claims the benefit of priority to Taiwan Patent Application No. 111122318, filed on Jun. 16, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a substrate material, and more particularly to a low-dielectric substrate material and a metal substrate using the same, such as a copper clad laminate (CCL).

### BACKGROUND OF THE DISCLOSURE

With the advancement of the fifth generation wireless system (5G wireless system), high frequency transmission has undoubtedly become the main development trend in an attempt to meet requirements of the 5G wireless system. Accordingly, relevant industries have strived to develop a high frequency substrate material for high frequency transmission (e.g., a frequency ranging from 6 GHz to 77 GHz), such that a high frequency substrate can be applied to a base station antenna, a satellite radar, an automotive radar, a wireless communication antenna, or a power amplifier.

Dielectric constant (Dk) and dielectric dissipation factor (Df) directly affect the speed and quality of transmitted signals. Therefore, materials with a low dielectric constant and an ultra-low dielectric dissipation factor are required for 5G applications to improve signal delay and reduce signal loss. In addition, other properties such as a desired thermal conductivity and heat resistance are also required for the 5G applications. Hereinafter, the dielectric constant and the dielectric dissipation factor are collectively referred to as dielectric properties of the high frequency substrate.

A low-dielectric substrate material that is currently available on the market usually contains a certain amount of a liquid rubber. The liquid rubber has both a high solubility and a reactive functional group, so that the low-dielectric substrate material can be used as the high frequency substrate material. However, the liquid rubber cannot be added without limit. If an amount of the liquid rubber is higher than 25 wt %, a glass transition temperature (Tg) of the low-dielectric substrate material becomes lower, and a peeling strength of a substrate made from the low-dielectric substrate material becomes weaker.

In addition, the low-dielectric substrate material also contains a certain amount of one or more thermal conductive fillers so as to increase a thermal conductivity thereof. Relative to 100 phr of a resin material, an amount of the one or more thermal conductive fillers ranges from a value larger than 45 phr to 60 phr. However, an excessive amount of the one or more thermal conductive fillers can negatively affect a compatibility between the resin material and the one or more thermal conductive fillers. As a result, a heat resistance of the substrate is decreased and the low-dielectric substrate material is not suitable to be applied to the high frequency substrate material.

### SUMMARY OF THE DISCLOSURE

In response to the above-referenced technical inadequacies, the present disclosure provides a low-dielectric substrate material and a metal substrate using the same.

In one aspect, the present disclosure provides a low-dielectric substrate material that includes a rubber resin composition, at least one inorganic filler, and borosilicate-type hollow microparticles. The rubber resin composition includes 30 wt % to 60 wt % of a liquid rubber, 10 wt % to 40 wt % of a polyphenylene ether resin, and 10 wt % to 40 wt % of a crosslinker. A molecular weight of the liquid rubber ranges from 2500 g/mol to 6000 g/mol. The at least one inorganic filler is selected from the group consisting of magnesium oxide, aluminum oxide, silicon oxide, zinc oxide, aluminum nitride, boron nitride, silicon carbide, and aluminum silicate. An amount of the borosilicate-type hollow microparticles is not more than 10 phr relative to 100 phr of the rubber resin composition.

In one embodiment of the present disclosure, each of the borosilicate-type hollow microparticles has a shell and a hollow core filled with air. In one embodiment of the present disclosure, each of the borosilicate-type hollow microparticles has a D50 particle size between 10 μm and 30 μm and a true density between 0.4 g/cm³ μm and 0.6 g/cm³.

In one embodiment of the present disclosure, the shell of each of the borosilicate-type hollow microparticles has an acrylic group or a vinyl group on a surface thereof.

In one embodiment of the present disclosure, relative to 100 phr of the rubber resin composition, an amount of the at least one inorganic filler ranges from 30 phr to 60 phr.

In one embodiment of the present disclosure, the at least one inorganic filler includes the aluminum oxide and the silicon oxide, and a total amount of the aluminum oxide and the silicon oxide ranges from 20 phr to 45 phr.

In one embodiment of the present disclosure, the shell of each of the borosilicate-type hollow microparticles has an acrylic group or a vinyl group on a surface thereof.

In one embodiment of the present disclosure, relative to 100 phr of the rubber resin composition, the amount of the borosilicate-type hollow microparticles ranges from 1 phr to 7 phr, and the amount of the at least one inorganic filler ranges from 35 phr to 55 phr.

In one embodiment of the present disclosure, the liquid rubber is formed from at least one monomer of a styrene monomer, a butadiene monomer, a divinylbenzene monomer, and a maleic anhydride monomer.

In one embodiment of the present disclosure, the liquid rubber contains 30 mol % to 90 mol % of a vinyl end group and 10 mol % to 50 mol % of a styrene end group based on total end groups thereof.

In one embodiment of the present disclosure, the low-dielectric substrate material further includes a siloxane coupling agent that has an acryl group or a vinyl group, and relative to 100 phr of the rubber resin composition, an amount of the siloxane coupling agent ranges from 0.1 phr to 5 phr.

In another aspect, the present disclosure provides a metal substrate that includes a substrate layer and at least one metal layer disposed on the substrate layer, and a material of the substrate layer includes the low-dielectric substrate material that has the above-mentioned composition.

In one embodiment of the present disclosure, the metal substrate has a dielectric constant from 2.8 to 3 at 10 GHz and a dielectric dissipation factor less than 0.003 at 10 GHz.

Therefore, in the low-dielectric substrate material and the metal substrate provided by the present disclosure, by virtue of the rubber resin composition including 30 wt % to 60 wt % of a liquid rubber, 10 wt % to 40 wt % of a polyphenylene ether resin, and 10 wt % to 40 wt % of a crosslinker, a molecular weight of the liquid rubber ranging from 2500 g/mol to 6000 g/mol, and an amount of the borosilicate-type hollow microparticles being not more than 10 phr relative to 100 phr of the rubber resin composition, requisite properties such as lower dielectric properties, a higher peeling strength, and a higher heat resistance, can be achieved in practical applications.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a metal substrate using a low-dielectric substrate material of the present disclosure;

FIG. 2 is another schematic view of the metal substrate using the low-dielectric substrate material of the present disclosure; and

FIG. 3 is a schematic view of borosilicate-type hollow microparticles of the low-dielectric substrate material of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Low-Dielectric Substrate Material

The present disclosure provides a low-dielectric substrate material, in which at least one inorganic filler and borosilicate-type hollow microparticles (also referred to as “hollow ball”) are introduced into a rubber resin system. Accordingly, the properties of the rubber resin system can meet requirements of a high-frequency high-speed substrate, and is more suitable to be used as a material of the high-frequency high-speed substrate than the conventional materials.

More specifically, the low-dielectric substrate material of the present disclosure includes a rubber resin composition, at least one inorganic filler, and borosilicate-type hollow microparticles. The at least one inorganic filler and the borosilicate-type hollow microparticles are uniformly dispersed in the rubber resin composition. The following description will illustrate the rubber resin composition, the at least one inorganic filler, and the borosilicate-type hollow microparticles in greater detail.

### Rubber Resin Composition

In the present disclosure, the rubber resin composition mainly includes 30 wt % to 60 wt % of a liquid rubber, 10 wt % to 40 wt % of a polyphenylene ether resin, and 10 wt % to 40 wt % of a crosslinker, and a molecular weight of the liquid rubber ranges from 2500 g/mol to 6000 g/mol.

It is worth mentioning that, when the molecular weight of the liquid rubber ranges from 2500 g/mol to 6000 g/mol, the rubber resin composition would have an increased flowability, such that the gap filling ability of the low-dielectric substrate material can be improved. The molecular weight of the liquid rubber preferably ranges from 3000 g/mol to 5500 g/mol, and more preferably ranges from 3000 g/mol to 5000 g/mol. The liquid rubber has a high solubility, which can increase a compatibility between components of the rubber resin composition. Furthermore, the liquid rubber contains reactive functional groups, which can increase a degree of crosslinking of the low-dielectric substrate material after being cured.

In addition, the liquid rubber has a specific molecular weight and molecular structure and is derived from specific monomers. Therefore, the liquid rubber can be added in a greater amount to the rubber resin composition, i.e., an amount of the liquid rubber in the rubber resin composition can be increased greatly. More specifically, the liquid rubber is formed from at least one of butadiene, styrene, divinylbenzene, and maleic anhydride monomers. The liquid rubber contains 30 mol % to 90 mol % of a vinyl end group and 10 mol % to 50 mol % of a styrene end group based on total end groups thereof. Furthermore, based on a total weight of the rubber resin composition being 100 wt %, the amount of the liquid rubber can be higher than 40 wt %, and is significantly higher than an amount of a liquid rubber in a rubber resin composition of the related art, which is about 25 wt %.

It is worth mentioning that, when an amount of the vinyl end group ranges from 30 mol % to 90 mol % of the total end groups of the liquid rubber, the liquid rubber would have a better heat resistance and a better system compatibility with the polyphenylene ether resin. When an amount of the styrene end group ranges from 10 mol % to 50 mol % of the total end groups of the liquid rubber, the crosslinking reaction of the liquid rubber with the polyphenylene ether resin can be facilitated, thereby increasing system compatibility.

In certain embodiments, based on the total weight of the rubber resin composition being 100 wt %, the amount of the liquid rubber can be 30 wt %, 35 wt %, 40 wt %, 45 wt %, 50 wt %, 55 wt %, or 60 wt %.

In certain embodiments, the liquid rubber includes a liquid diene rubber, which has a high percentage of a side chain containing a vinyl group (preferably containing a 1,2-vinyl group). It is worth mentioning that in the presence of one or more side chains containing a vinyl group, a cured product of a substrate material can be provided with an increased crosslink density and an increased heat resistance. Specifically, the liquid rubber is composed of a butadiene monomer, which can be a polymer formed from the butadiene monomer only or a copolymer formed from the butadiene monomer and other monomers. In other words, the liquid rubber can be a butadiene homopolymer or a butadiene copolymer, and is preferably a butadiene homopolymer.

In certain embodiments, based on a total amount of the butadiene monomer being 100 mol %, 30 mol % to 98 mol % of the butadiene monomer after polymerization has a side chain containing a vinyl group. Preferably, 50 mol % to 98 mol % of the butadiene monomer after polymerization has a side chain containing a vinyl group. More preferably, 65 mol % to 98 mol % of the butadiene monomer after polymerization has a side chain containing a vinyl group.

In certain embodiments, the liquid rubber is composed of butadiene and styrene monomers, and based on a total amount of the butadiene and styrene monomers being 100 mol %, an amount of the styrene monomer ranges from 10 mol % to 50 mol %. Accordingly, the liquid rubber can have a molecular geometric structure similar to an arrangement of liquid crystals, thereby increasing heat resistance and system compatibility.

In certain embodiments, the liquid rubber is composed of butadiene, styrene, divinylbenzene, and maleic anhydride monomers, i.e., the liquid rubber is a copolymer formed from the butadiene, styrene, divinylbenzene, and maleic anhydride monomers. Based on a total weight of the styrene, butadiene, divinylbenzene, and maleic anhydride monomers being 100 mol %, an amount of the butadiene monomer ranges from 30 mol % to 90 mol %, an amount of the styrene monomer ranges from 10 mol % to 50 mol %, an amount of the divinylbenzene monomer ranges from 10 mol % to 40 mol %, and an amount of the maleic anhydride monomer ranges from 2 mol % to 20 mol %.

In a polymer system of the present disclosure, a molecular weight of the polyphenylene ether resin ranges from 1000 g/mol to 20000 g/mol, preferably ranges from 2000 g/mol to 10000 g/mol, and more preferably ranges from 2000 g/mol to 2200 g/mol. It should be noted that, the polyphenylene ether resin has a better solvent solubility when a molecular weight thereof is lower than 20000 g/mol, which is advantageous for preparing the rubber resin composition.

In certain embodiments, based on the total weight of the rubber resin composition being 100 wt %, the amount of the polyphenylene ether resin can be 10 wt %, 15 wt %, 20 wt %, 25 wt %, 30 wt %, 35 wt %, or 40 wt %.

In certain embodiments, the polyphenylene ether resin can have at least one modifying group. The at least one modifying group can be selected from the group consisting of: a hydroxyl group, an amino group, a vinyl group, a styrene group, a methacrylate group, and an epoxy group. The at least one modifying group of the polyphenylene ether resin can provide one or more unsaturated bonds to facilitate a crosslinking reaction. Accordingly, a substrate material having a high glass transition temperature and a good heat resistance can be obtained. In practice, two opposite ends of the molecular structure of the polyphenylene ether resin each have a modifying group, and the two modifying groups are the same. In addition, the polymer system of the present disclosure can include one kind of polyphenylene ether or two or more different kinds of polyphenylene ether.

In certain embodiments, the polymer system of the present disclosure can include a first polyphenylene ether and a second polyphenylene ether. The first polyphenylene ether and the second polyphenylene are different from each other, and can each be independently a polyphenylene ether that has two hydroxyl modifying groups at molecular ends thereof, a polyphenylene ether that has two methacrylate modifying groups at molecular ends thereof, a polyphenylene ether that has two styrene modifying groups at molecular ends thereof, or a polyphenylene ether that has two epoxy modifying groups at molecular ends thereof. However, the present disclosure is not limited thereto. Furthermore, a weight ratio of the first polyphenylene ether to the second polyphenylene ether ranges from 0.5 to 1.5, preferably ranges from 0.75 to 1.25, and is more preferably 1.

In the polymer system of the present disclosure, the crosslinker of the present disclosure can increase a crosslinking degree of the polyphenylene ether resin and the liquid rubber. In the present embodiment, the crosslinker can include an allyl group. For example, the crosslinker can be triallyl cyanurate (TAC), triallyl isocyanurate (TAIC), diallyl phthalate, divinylbenzene, triallyl trimellitate, or any combination thereof. Preferably, the crosslinker is triallyl isocyanurate. However, the present disclosure is not limited thereto.

In certain embodiments, based on the total weight of the rubber resin composition being 100 wt %, the amount of the crosslinker can be 10 wt %, 15 wt %, 20 wt %, 25 wt %, 30 wt %, 35 wt %, or 40 wt %.

### Borosilicate-Type Hollow Microparticles

Referring to FIG. 3, a schematic view of the borosilicate-type hollow microparticles of the low-dielectric substrate material of the present disclosure is shown. The addition of the borosilicate-type hollow microparticles 11 can allow a cured product of a substrate material to have low dielectric properties, especially a dielectric dissipation factor of less than 0.0030, which is advantageous for high frequency applications. As shown in FIG. 3, the borosilicate-type hollow microparticles 11 has a shell 111 and a hollow core 112 filled with air. The borosilicate-type hollow microparticles 11 can be made of alkaline borosilicate glass (e.g., a product under the name of “iM16K” available from 3M Company). In certain embodiments, the hollow core 112 of the borosilicate-type hollow microparticles 11 can be filled with nitrogen gas or an inert gas.

Considering the overall performance and the range of applications of the cured product of the substrate material, a balance between low dielectric properties and mechanical properties is required, i.e., the low dielectric properties can be achieved without negatively affecting the mechanical properties. For this purpose, the borosilicate-type hollow microparticles 11 has a D50 particle size between 10 μm and 30 μm and a true density between 0.4 g/cm³ μm and 0.6 g/cm³. Relative to 100 phr of the rubber resin composition, an amount of the borosilicate-type hollow microparticles 11 is not more than 10 phr, and preferably ranges from 1 phr to 7 phr. If the amount of the borosilicate-type hollow microparticles 11 is greater than 10 phr, a bonding strength between a substrate and a copper foil may be negatively affected.

In order to further reduce a dielectric dissipation factor without lowering required properties of practical applications such as a peel strength and a heat resistance, the shell 111 of the borosilicate-type hollow microparticles 11 can have a sufficient number of at least one of an acrylic group and a vinyl group (i.e., at least one modifying functional group) on a surface thereof. In practice, the borosilicate-type hollow microparticles 11 can be surface-treated with a silane-containing compound having at least one of the acrylic group and the vinyl group. Accordingly, at least one of the acrylic group and the vinyl group is bonded to the surface of the shell 111. For example, a surface treatment method includes impregnating the borosilicate-type hollow microparticles 11 with a treatment agent including the silane-containing compound. The above description is for exemplary purposes only and is not intended to limit the scope of the present disclosure.

### Inorganic Filler

In the polymer system of the present disclosure, the presence of the at least one inorganic filler can increase the mechanical properties and the thermal conductivity of the low-dielectric substrate material, and can maintain the dielectric constant and the dielectric dissipation factor of a cured product of the low-dielectric substrate material at a relatively low level. The above description is not intended to limit the scope of the present disclosure. In practice, the at least one inorganic filler may achieve other beneficial effects or provide other functions, such as increasing a heat resistance and a bonding strength (after curing) of the low-dielectric substrate material and lowering the viscosity of the low-dielectric substrate material.

The at least one inorganic filler can be selected from the group consisting of magnesium oxide (MgO), aluminum oxide (Al₂O₃), silicon oxide (SiO₂), zinc oxide (ZnO), aluminum nitride (AlN), boron nitride (BN), silicon carbide (SiC), and aluminum silicate (Al₂O₃.SiO₂). An average particle size of the at least one inorganic filler can range from 1 μm to 20 μm. Relative to 100 phr of the rubber resin composition, an amount of the at least one inorganic filler ranges from 30 phr to 60 phr, and preferably ranges from 35 phr to 55 phr. Considering the overall performance and the range of applications of the cured product of the substrate material, a balance between low dielectric properties and mechanical properties is required. For this purpose, the at least one inorganic filler preferably includes aluminum oxide and silicon oxide, and a total amount of the aluminum oxide and the silicon oxide ranges from 20 phr to 45 phr.

In certain embodiments, relative to 100 phr of the rubber resin composition, the amount of the at least one inorganic filler can be 30 phr, 35 phr, 40 phr, 45 phr, 50 phr, 55 phr, or 60 phr.

In certain embodiments, the at least one inorganic filler can be spherical silica (e.g., the product under the name of EQ-2410 produced by Zhejiang Third Age Material Technology Co., Ltd).

In certain embodiments, the at least one inorganic filler can be surface-modified to have a sufficient number of at least one of an acrylic group and a vinyl group (i.e., at least one modifying functional group) on a surface thereof, so as to increase the system compatibility with the polymer system. Accordingly, the at least one inorganic filler can be added in a greater amount to the low-dielectric substrate material without negatively affecting the properties (e.g., a heat resistance) of a cured product of the low-dielectric substrate material.

In practice, the at least one inorganic filler can include a single inorganic powder or a mixture of different inorganic powders, and can be formed by full or partial surface-treatment. In one example of the at least one inorganic filler including aluminum oxide and silicon oxide, each of the aluminum oxide and the silicon oxide is surface-modified to have at least one of an acrylic group and a vinyl group on a surface thereof. In another one example of the at least one inorganic filler including aluminum oxide and silicon oxide, only the aluminum oxide is surface-modified to have at least one of an acrylic group and a vinyl group on a surface thereof, and the silicon oxide is not surface-modified. The above description is for exemplary purposes only and is not intended to limit the scope of the present disclosure.

In practice, the at least one inorganic filler can be surface-treated with a silane-containing compound having at least one of the acrylic group and the vinyl group. Accordingly, at least one of the acrylic group and the vinyl group is bonded to the surface of the at least one inorganic filler. For example, a surface treatment method includes impregnating the at least one inorganic filler with a treatment agent including the silane-containing compound. The above description is for exemplary purposes only and is not intended to limit the scope of the present disclosure.

### Siloxane Coupling Agent

The low-dielectric substrate material of the present disclosure can further include a siloxane coupling agent. One end of the siloxane coupling agent is a silicone end that is able to bond with inorganic substances, and another one end of the siloxane coupling agent has a functional group that is able to bond with a rubber or resin. Therefore, in the presence of the siloxane coupling agent, a compatibility between a fiber cloth, a rubber or resin, and at least one inorganic filler can be improved, thereby increasing mechanical properties and a heat resistance of a cured product of the low-dielectric substrate material.

Specifically, the siloxane coupling agent has at least one of an acryl group and a vinyl group. A molecular weight of the siloxane coupling agent can range from 100 g/mol to 500 g/mol, preferably ranges from 110 g/mol to 250 g/mol, and more preferably ranges from 120 g/mol to 200 g/mol. Relative to 100 phr of the rubber resin composition, an amount of the siloxane coupling agent can range from 0.1 phr to 5 phr, and preferably ranges from 0.5 phr to 3 phr. The above description is for exemplary purposes only and is not intended to limit the scope of the present disclosure.

In certain embodiments, relative to 100 phr of the rubber resin composition, the amount of the siloxane coupling agent can be 0.1 phr, 0.5 phr, 1 phr, 1.5 phr, 2 phr, 2.5 phr, 3 phr, 3.5 phr, 4 phr, 4.5 phr, or 5 phr.

### Flame Retardant

The low-dielectric substrate material of the present disclosure can further include a flame retardant. In the presence of the flame retardant, a flame retardant property of a cured product of the low-dielectric substrate material can be improved. Specifically, the flame retardant can be a phosphorus flame retardant or a brominated flame retardant. Preferably, the flame retardant does not contain halogen. Relative to 100 phr of the rubber resin composition, an amount of the flame retardant can range from 0.1 phr to 5 phr, and preferably ranges from 0.5 phr to 3 phr. The above description is for exemplary purposes only and is not intended to limit the scope of the present disclosure.

Specific examples of the brominated flame retardant include: ethylene bistetrabromophthalimide, tetradecabromodiphenoxy benzene, and decabromo diphenoxy oxide. However, such examples are not intended to limit the present disclosure.

Specific examples of the phosphorus flame retardant include: sulphosuccinic acid ester, phosphazene, ammonium polyphosphate, melamine polyphosphate, and melamine cyanurate. The sulphosuccinic acid ester can be exemplified by triphenyl phosphate (TPP), tetraphenyl resorcinol bis(diphenylphosphate) (RDP), bisphenol A bis(diphenyl phosphate) (BPAPP), bisphenol A bis(dimethyl phosphate) (BBC), resorcinol diphosphate (e.g., the product under the name of CR-733S produced by Daihachi Chemical Industry Co., Ltd.), resorcinol-bis(di-2,6-dimethylphenyl phosphate) (e.g., the product under the name of PX-200 produced by Daihachi Chemical Industry Co., Ltd.), and paraxylylene bisdiphenylphosphine oxide (e.g., the product under the name of PQ-60 produced by Chin Yee Chemical Industries Ltd.). However, such examples are not intended to limit the present disclosure.

In certain embodiments, relative to 100 phr of the rubber resin composition, the amount of the flame retardant can be 0.1 phr, 0.5 phr, 1 phr, 1.5 phr, 2 phr, 2.5 phr, 3 phr, 3.5 phr, 4 phr, 4.5 phr, or 5 phr.

### Metal Substrate

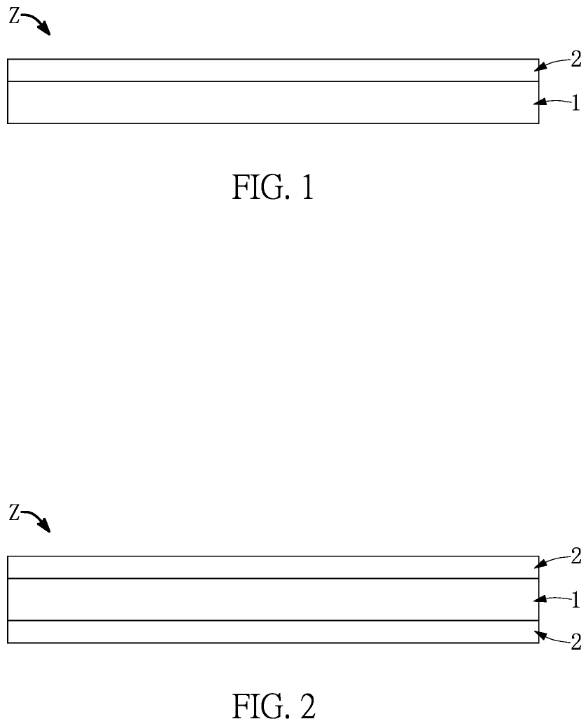

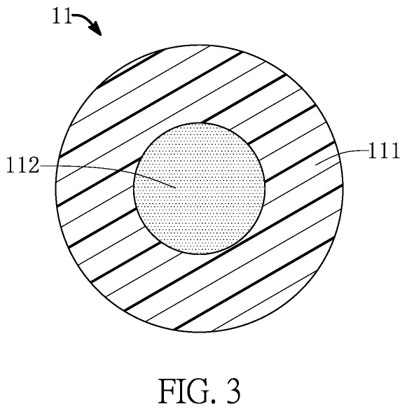

Referring to FIG. 1 and FIG. 2, the present disclosure further provides a metal substrate Z that includes a substrate layer 1 and at least one metal layer 2 disposed on the substrate layer 1. A material of the substrate layer 1 includes the low-dielectric substrate material that has the above-mentioned components such as the rubber resin composition, the at least one inorganic filler, and the borosilicate-type hollow microparticles. Specifically, the metal substrate Z can be a copper clad laminate (CCL), and can include only one metal layer 2 (e.g., a copper foil layer) formed on a surface (e.g., an upper surface) of the substrate layer 1. Alternatively, the metal substrate Z can include two metal layers 2 respectively formed on two opposite surfaces (e.g., upper and lower surfaces) of the substrate layer 1.

It is worth mentioning that the substrate layer 1 is formed from the low-dielectric substrate material, such that it can have low dielectric properties, a good peeling strength, and a good heat resistance. Experimental results show that a dielectric constant (Dk) of the metal substrate Z measured at 10 GHz ranges from 2.8 to 3.0, and a dielectric dissipation factor (Df) of the metal substrate Z measured at 10 GHz is lower than 0.0030. Furthermore, a peeling strength of the metal substrate Z ranges from 3 lb/in to 5 lb/in.

The properties of the metal substrate Z are measured by methods below.
(1) Dielectric constant (10 GHz): detecting the dielectric constant of the metal substrate at 10 GHz by a dielectric analyzer (model: HP Agilent E5071C).
(2) Dissipation factor (10 GHz): detecting the dielectric dissipation factor of the metal substrate at 10 GHz by the dielectric analyzer (model: HP Agilent E5071C).
(3) Peeling strength: measuring the peeling strength of the metal substrate according to the IPC-TM-650-2.4.8 test method.
(4) Thermal conductivity: measuring a thermal conductivity of the metal substrate according to the ASTM D5470 test method.

### Beneficial Effects of the Embodiments

In conclusion, in the low-dielectric substrate material and the metal substrate provided by the present disclosure, by virtue of the rubber resin composition including 30 wt % to 60 wt % of a liquid rubber, 10 wt % to 40 wt % of a polyphenylene ether resin, and 10 wt % to 40 wt % of a crosslinker, a molecular weight of the liquid rubber ranging from 2500 g/mol to 6000 g/mol, and an amount of the borosilicate-type hollow microparticles being not more than 10 phr relative to 100 phr of the rubber resin composition, requisite properties such as lower dielectric properties, a higher peeling strength, and a higher heat resistance, can be achieved in practical applications. Such beneficial effects can be verified by experimental data shown in Table 1.

TABLE 1

| | Example 1 | Comparative Example 1 | Comparative Example 2 |
|---|---|---|---|
| | (with modified borosilicate- | (with non-modified borosilicate- | (with no borosilicate- |
| Items | type hollow microparticles) | type hollow microparticles) | type hollow microparticles) |
| Components (wt %) | Liquid rubber | Liquid rubber | Liquid rubber |
| | (MW = 4200 g/mol): 40% | (MW = 4200 g/mol): 40% | (MW = 4200 g/mol): 40% |
| | PPE resin: 45% | PPE resin: 45% | PPE resin: 45% |
| | Crosslinker (TAIC): 15% | Crosslinker (TAIC): 15% | Crosslinker (TAIC): 15% |
| | (The above components are | (The above components are | (The above components are |
| | formed into a rubber resin | formed into a rubber resin | formed into a rubber resin |
| | composition) | composition) | composition) |
| | Flame retardant (PQ-60): | Flame retardant (PQ-60): | Flame retardant (PQ-60): |
| | 8.3 phr (relative 100 phr of the | 8.3 phr (relative 100 phr of the | 8.3 phr (relative 100 phr of the |
| | rubber resin composition) | rubber resin composition) | rubber resin composition) |
| | Spherical silica (EQ-2410): | Spherical silica (EQ-2410): | Spherical silica (EQ-2410): |
| | 53.3 phr (relative 100 phr of the | 53.3 phr (relative 100 phr of the | 58.3 phr (relative 100 phr of the |
| | rubber resin composition) | rubber resin composition) | rubber resin composition) |
| | Modified borosilicate-type | Non-modified borosilicate-type | |
| | hollow microparticles: | hollow microparticles: | |
| | 5 phr (relative 100 phr of the | 5 phr (relative 100 phr of the | |
| | rubber resin composition) | rubber resin composition) | |
| Peeling strength (lb/in) | 4.0 | 3.2 | 4.0 |
| Water absorption rate | 0.30 | 0.30 | 0.30 |
| for 2 hours (%) | | | |
| Heat resistance test | OK | NG | OK |
| For 2 hours (PCT) | | | |
| Dielectric constant (Dk) | 3.00 | 3.00 | 3.15 |
| at 10 GHz | | | |
| Dissipation factor (Df) | 0.0017 | 0.0020 | 0.0017 |
| at 10 GHz | | | |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A low-dielectric substrate material, comprising a rubber resin composition, at least one inorganic filler, and borosilicate-type hollow microparticles, wherein the rubber resin composition includes:
30 wt % to 60 wt % of a liquid rubber, a molecular weight of the liquid rubber ranging from 2500 g/mol to 6000 g/mol;
10 wt % to 40 wt % of a polyphenylene ether resin; and
10 wt % to 40 wt % of a crosslinker;
wherein the at least one inorganic filler is selected from the group consisting of magnesium oxide, aluminum oxide, silicon oxide, zinc oxide, aluminum nitride, boron nitride, silicon carbide, and aluminum silicate;
wherein relative to 100 phr of the rubber resin composition, an amount of the borosilicate-type hollow microparticles is not more than 10 phr.

2. The low-dielectric substrate material according to claim 1, wherein each of the borosilicate-type hollow microparticles has a shell and a hollow core filled with air.

3. The low-dielectric substrate material according to claim 2, wherein each of the borosilicate-type hollow microparticles has a D50 particle size between 10 μm and 30 μm and a true density between 0.4 g/cm³ μm and 0.6 g/cm³.

4. The low-dielectric substrate material according to claim 2, wherein the shell of each of the borosilicate-type hollow microparticles has an acrylic group or a vinyl group on a surface thereof.

5. The low-dielectric substrate material according to claim 1, wherein relative to 100 phr of the rubber resin composition, an amount of the at least one inorganic filler ranges from 30 phr to 60 phr.

6. The low-dielectric substrate material according to claim 5, wherein the at least one inorganic filler includes the aluminum oxide and the silicon oxide, and a total amount of the aluminum oxide and the silicon oxide ranges from 20 phr to 45 phr.

7. The low-dielectric substrate material according to claim 5, wherein the shell of each of the borosilicate-type hollow microparticles has an acrylic group or a vinyl group on a surface thereof.

8. The low-dielectric substrate material according to claim 5, wherein relative to 100 phr of the rubber resin composition, the amount of the borosilicate-type hollow microparticles ranges from 1 phr to 7 phr, and the amount of the at least one inorganic filler ranges from 35 phr to 55 phr.

9. The low-dielectric substrate material according to claim 1, wherein the liquid rubber is formed from at least one monomer of a styrene monomer, a butadiene monomer, a divinylbenzene monomer, and a maleic anhydride monomer.

10. The low-dielectric substrate material according to claim 9, wherein the liquid rubber contains 30 mol % to 90 mol % of a vinyl end group and 10 mol % to 50 mol % of a styrene end group based on total end groups thereof.

11. The low-dielectric substrate material according to claim 1, further comprising a siloxane coupling agent that has an acryl group or a vinyl group, and relative to 100 phr of the rubber resin composition, an amount of the siloxane coupling agent ranges from 0.1 phr to 5 phr.

12. A metal substrate comprising a substrate layer and at least one metal layer disposed on the substrate layer, wherein a material of the substrate layer includes the low-dielectric substrate material as claimed in claim 1.

13. The metal substrate according to claim 12, wherein the metal substrate has a dielectric constant from 2.8 to 3 and a dielectric dissipation factor less than 0.003.
